(19) United States
(12) Patent Application Publication
(10) Pub. No.: US 2015/0327571 A1
(43) Pub. Date: Nov. 19, 2015

(54) METHOD OF COATING FROZEN CONFECTIONS

(71) Applicant: NESTEC S.A., Vevey (CH)

(72) Inventor: Thomas Aloisius Valentinus Amend, Mountain View, CA (US)

(21) Appl. No.: 14/367,761

(22) PCT Filed: Dec. 17, 2012
(86) PCT No.: PCT/EP12/75822

§ 371 Date: Jun. 20, 2014

(30) Foreign Application Priority Data
Dec. 22, 2011 (EP) 11195314.7

(51) Int. Cl. A23G 9/48; A23G 9/50; A23G 9/14; A23G 9/04

(52) U.S. Cl. CPC A23G 9/48; A23G 9/045; A23G 9/503; A23G 9/14; A23G 9/506; A23V 2002/00

(57) ABSTRACT

The present invention relates to a method of making a confectionery product, especially a frozen confection with a patterned coating, which comprises applying a liquid coating material to the surface of the confectionery product and allowing the coating material to flow down along the confectionery product. The present invention relates also to the corresponding coated confectionery product.

### TECHNICAL FIELD OF THE INVENTION

The present invention relates to a method of preparing a confectionery product, especially a frozen confection with a patterned coating. In particular the present invention relates to coating for frozen confections, such as ice cream bars, frozen confections on a stick, or frozen confections placed in a cone or sandwich. The invention furthermore relates to a confectionery product having a patterned coating, in particular to frozen confections on a stick, placed in a cone or a sandwich.

### BACKGROUND OF THE INVENTION

Coated frozen confections or ice cream bars are popular products. Generally, these products either have a solid chocolate coating fully surrounding the entire frozen confection, such as an ice cream bar. Alternatively, the product may have a partial coating made by dipping the frozen confection into a bath of liquid chocolate coating material. The coatings are solidified by cooling and the product may then be packaged. When traditional products of frozen confections are coated with a coating covering only a part of the product, generally the top of the product, the product will be held upside-down and dipped in a bath of chocolate. The line between the coating material and the uncoated part of the product will therefore as a result of dipping be a flat line.

In some known products two or more separate layers of coating can be present. The layers may either be of the same or different types. Further, the flavours and colours may be the same or different. However, the line between the coating material and the uncoated part of the product will also here be a flat line. It is not easy to apply a pattern of the coating material while dipping the product. Further, it is not easy to discontinue the coating of a frozen confection, it is difficult to produce a pattern of a coating to a frozen confection, where the line between the coating material and the uncoated part of the frozen confection is not a flat line from the technique known in the art.

In the prior art different examples of coating a frozen confection, such as an ice cream bar, ice cream stick or ice cream cone, with a decorative chocolate coating are described.

In the PCT application WO 02/082918 A1 a method and apparatus for applying a chocolate coating to a confectionery described, where the coating has a laced appearing coating preferably made from two or more type of chocolate, are described. The product comprises a first a layer of chocolate coating and a second layer placed in lines or stripes over the already coated product in a pattern.

In the PCT application WO 00/13524 an apparatus for preparing chocolate coating to a product is described, which coating have a marbled appearance.

In U.S. Pat. No. 6,251,455 a method of making striped coatings for confectioneries such as ice cream bars is described. The stripes are applied to the product in lines which can create different patterns. Several stripes can be applied simultaneously. The method may include applying a layer of coating onto the product either by spraying or dipping before or after the stripes are applied.

However, there is an unmet need for applying a partially coating, continuous layer to a confectionery product, which can create a borderline of the coating layer having an interesting pattern as compared to the traditional flat-line.

### SUMMARY OF THE INVENTION

An object of the present invention is to provide a method of making a confectionery product with a patterned coating, where the coating is applied by allowing the coating material to flow down along the confectionery product, such that a patterned coating layer is formed to provide a desired appearance.

In particular, it is an object of the present invention to provide a frozen confectionery having a pattern at the borderline of a partial coating layer.

The inventors of the present invention has surprisingly found that different patterns at the border line of a partial coating layer can be obtained by applying a coating material in liquid form to a confectionery product and allow the liquid coating material to flow down the product, such that a pattern of the coating material is obtained.

For a consumer, it is not only the taste of a frozen confection, for example an ice cream, which is important in deciding which product to buy, but also the appearance of a product is important. By the present invention, the problem of a traditional dipping process of a frozen product creating a flat line as the borderline between the coating material and uncoated parts, and thus resulting in a low visual effect and boring appearance, is solved.

The visual appearance to the consumer is improved by the present invention by creating interesting visual effects, such that different patterns of the coating material at the border line between the coated and uncoated parts of the product. Instead of a flat line, the invention allows to create a borderline that exhibits a wave pattern. Various sizes and shapes of the waves can be produced on the same product.

Thus, one aspect of the invention relates to a method of making a confectionery product, preferably frozen, with a patterned coating, comprising the steps of:

(i) providing a confectionery product having a surface;

(ii) providing a liquid coating material;

(iii) applying the liquid coating material to at least a part of the surface of the confectionery product;

(iv) allowing the coating material to flow down along the confectionery product; and

(v) solidifying the coating on the confectionery product to form a confectionery product with a patterned coating.

Another aspect of the present invention relates to a confectionery product comprising a patterned coating, wherein said confectionery product is obtained by the above mentioned method.

In general, the various aspects of the invention may be combined and coupled in any way possible within the scope of the invention. These and other aspects, features and/or advantages of the invention will be apparent from and elucidated with reference to the embodiments described hereinafter.

### DETAILED DESCRIPTION OF THE INVENTION

An aspect of the invention relates to a method of making a confectionery product with a patterned coating.

However, prior to discussing the present invention in further details, the following terms and conventions will first be defined.

In the context of the present invention, mentioned percentages are weight/weight percentages unless otherwise stated.

The term “and/or” used in the context of the “X and/or Y” should be interpreted as 15 “X”, or “Y”, or “X and Y”.

Confectionery Product:

The confectionery product may be any confectionery product which is suitable for applying a coating over it, but in particular a confectionery product which is suitable for partially coating. The confectionery product is preferably a frozen confectionery product, including frozen desserts, such as frozen confections on a stick, placed in an edible container, such as a ball top cone or a flame decor cone, placed in a sandwich of edible material, such as wafer and biscuit, or placed in a non-edible container.

A frozen confectionery on a stick may also be called ice lolly.

The edible container may for example be a cone, but it may have other shapes such as a bowl, a cup, a ball, a cylinder, a pyramid, a flower, and an animal.

The non-edible container may have various shapes, such as a cone, a bowl, a cup, a ball, a cylinder, a pyramid, a flower and an animal.

A cone may also be called a cornet. It is a dry cone shaped pastry, usually made of wafer similar in texture to a waffle, allowing frozen confection to be eaten without a bowl or a spoon. Examples of a cone is a ball top cone and flame decor cone. Various types of cones or cornets include wafer cones, waffle cones, cake cones, pretzel cones, chocolate cones and sugar cones.

The frozen confection may for example be ice cream, low fat ice cream, mellorine, ice milk, sherbet, sorbet, or frozen yoghurt. The confectionery product may be any conventional product which is coated, e.g. praline, cake, fondant.

In a preferred embodiment of the invention, the confectionery product is made of ice cream, low fat ice cream, mellorine, ice milk, sherbet, sorbet or frozen yoghurt and the confectionery product is either on a stick, placed in a cone, such as a ball top cones or a flame decor cones or an ice cream sandwich.

In a preferred embodiment of the invention, the confectionery product is placed on a stick, such as an ice lolly.

In the context of the present application the term “surface” means the external surface of a product, for example the exernal surface of an ice lolly or the external surface of the ice cream of an ice cream cone.

The transverse section of the confectionery product may be circular or it may have other shapes, for example triangular or square. If the transverse section is shaped as a triangle or a square, the external surface has 3 or 4 sides, respectively.

In another embodiment of the invention, the confectionery product is moulded. In the context of the present invention, the term “moulded” means that the confectionery product, for example an ice cream, has been moulded into a desired form of the product. Tridimensional articles can be formed by a moulding process.

In an embodiment of the invention, the confectionery product is a moulded frozen confection on a stick.

Coating Material:

An aspect of the present invention relates to a method of applying a coating material to a confectionery product.

In the context of the present invention, the coating material is in a liquid state when applied to the surface of the confectionery product, but the coating material must be able to solidify after coating. Thus, the coating material may be any material which is edible and which can change between a solid form and a liquid form.

In an embodiment of the present invention, the coating material is chocolate, jelly, fruit sauce preparations, compound coatings or a combination thereof. The term “compound coating” refers to a coating material based on fats other than cocoa butter, including milk fats such as coconut oil, palm kernel oil soybean oil or a blend of such oils. The coating material may for example be a light milk chocolate compound coating or a dark chocolate compound coating as described in Marshall et al, “Ice Cream”, 6. Ed. 2003, Kluwer Academic/PlenumPublishers, page 288. The light milk chocolate compound coating comprises 6% natural process cocoa, 28.5% sugar, 55% lauric fat, 10% nonfat dry milk, 0.5% lecithin, 0.03% vanillin, while the dark chocolate compound coating comprises 10% Dutch process cocoa, 33% sugar, 56.5% lauric fat, 0.5% lecithin, 0.03% vanillin. The fat added to the compound coatings is palm kernel oil or coconut oil.

The term “liquid” will in the context of the present invention relate to materials having a fluidity such that the material can flow down along a product by gravitation when applied. The flow properties of the coating material when being applied to at least a part of the surface of the confectionery product may be measurerable and expressed in the two values; plastic viscosity and yield value. If a coating material is too thick and too viscous, the flowing of the coating material down along the product will be insufficient. A coating material that is too thin, on the other hand, will lead the coating material flowing too fast down along the product, such that a thin coating layer is made, which have the possibilities of breaking. A coating material with the right degree of viscosity and yield value will flow evenly down the external surface of a product.

For optimum flow properties, the coating material has a plastic viscosity from about 5 to 300 centipoise, preferably from 8 to 280 centipoise, more preferably from 10 to 250 centipoise, such as from 15 to 230 centipoise, even more preferably from 20 to 200 centipoise, such as from 30 to 190, for example from 40 to 180, preferably from 50 to 170, such as from 60 to 150. The viscosity of the liquid coating material differs depending of which coating material is used

In an embodiment of the invention, a liquid fat based chocolate compound is used as coating material, which has a viscosity of 60-150 centipoise.

In an embodiment of the invention, the yield value of the coating material is from about 1 to 40 dynes/cm², preferably from 5 to 25 dynes/cm².

The term “yield value” refers to the shear stress required to initiate flow of a coating material and relates to the coating or decorating characteristics, the thickness of the coating layer and how quickly a coating material firms up, i.e. becomes solid.

The term “plastic viscosity” or simply “viscosity” is a function of the shear strees required to maintain constant flow. This parameter determines how well the coating material will flow.

Flow properties having the right yield value and viscosity will allow the coating material to flow down along the external surface of the confectionery product in a desirable speed after being applied. Viscosity and yield value can be calculated from multiple torque readings taken with a Brookfield RV viscometer with SC4-28 spindle, using modified Casson equation for chocolate viscometry.

A solid coating material will become liquid by heating the material above its melting point. When heating above its melting point, the coating material becomes liquid, and the coating material becomes solid again by cooling the coating material after applied. In some embodiments a cooling process is not explicitly needed, but the coating material is cooled, just by leaving the coating material on the product in environments cool enough for the coating material to solidify.

If for example a coating material is in a solid form at room temperature it may be heated such that it is melted into a liquid phase. A coating material typically used in the field of coating frozen confections is a compound coating,. i.e. a fat based chocolate compound coating, with the main ingredients being a fat such as coconut oil, palm oil, cocoa powder and sugar. Real chocolate is another example of a coating material which is liquid at high temperature, temperatures above about 35 C° C., and solid at temperatures below about 30° C. The exact temperatures for a chocolate to be liquid/solid is however depending on the composition of the chocolate. At temperatures between 28 and 32° C. (depending on the composition) a typical coating material is semi solid. Thus, when heating chocolate, it will change from a solid phase to a liquid phase. However, the solid/liquid state of a chocolate depend of which type of chocolate is used, for example dark chocolate, milk chocolate or white chocolate.

In a preferred embodiment of the invention, the coating material is chocolate.

The chocolate may be chocolate according to accepted regulations or it may be a fat containing confectionery compound material comprising sugar, milk derived components, and fat and solids from vegetable or cocoa sources in differing proportions having a moisture content less than about 10 percent, preferably less than about 5 percent by weight. The fat containing material may be a chocolate substitute containing direct cocoa butter replacements, stearines, coconut oil, palm oil, butter, or any mixture thereof, nut pastes such as peanut butter and fat; praline; confectioner's coatings used for covering cakes usually comprising chocolate analogues with cocoa butter replaced by a less expensive non-tempering fat; or a mixture of non-cocoa butter fats, sugar and milk sold by Nestlé.

Different types of chocolate as a coating material may be used, for example milk chocolate, dark chocolate, white chocolate, or combinations thereof.

In an embodiment of the invention a part of the chocolate is substituted with a fat component.

In an embodiment of the invention the coating material is a compound coating.

A compound coating is a fat based coating as usually used and well known for the skilled person producing chocolate coated stick products. Examples can be found in Marshall, Goff, Hartel: Ice Cream, Sixth Ed., 2003, Kluwer Academic/PlenumPublishers, page 288.

In another preferred embodiment of the invention, a fruit sauce preparation is the coating material.

Examples of fruit sauce preparations may be selected from the group of sauces made from, strawberry, raspberry, blueberry, orange, lemon, mango, blackcurrant, pineapple, etc. Preparations will become viscous when in contact with the surface of the frozen confection and will freeze to a semisolid or solid material due to extraction of heat by the frozen confection.

In still another embodiment of the invention the coating material is a jelly.

In the context of the present invention, the term “jelly” relates to a coating material which is chewy and firm when in a solid phase.

One type of jelly is liquid at high temperatures, but solid a lower temperatures. The temperature at which the jelly is liquid depends on the type of jelly system. The jelly is then liquid when applied to the confectionery product but after cooling the jelly becomes solid.

In another type of jelly, the jelly is liquid at lower temperature, such as room temperature, and solidify upon contact with a gelling agent. An example of such a gelling agent is alginate which gellifies when in contact with calcium.

In general, a jelly is produced on basis of a cooked mass comprising water, sweetening agent (sugars and/or sugar alcohols), colours (optionally), flavours, and texture giving agents. The cooked mass may be subject to various treatments.

The texture giving agent used in jellies may also be defined by the following terms; “texturizing agents”, and “gelling agents”. These terms may be used interchangeable. In a jelly, the texture giving agent is defined as compounds with the capability of modulating the texture of the product without contributing with a significant increase in energy content. As discussed above, the jellies will in a solid phase be firm and chewy. In other word, the structure may be defined as elastic or gelled. It is the texture giving agent in the jelly which are responsible for the elastic property of a jelly.

Examples of texture giving agents include gelatine, pectin, starch as e.g. natural and/or modified starch, carrageenan, gum Arabic, alginate, gellan gum, agar-agar (identical to agar), etc.

Another characteristic of a jelly is that it is a solid coating material with a tree dimensional network structure formed in connection with the gelling/boiling procedure resulting in products with elastic properties. The three dimensional network is normally conferred by addition of texture giving agents prior to boiling of the mass. In fact, the coating material is a liquid and will remain in a liquid phase even when cooling if no texture giving agent is present.

The structure of the jelly depends on how much texture giving agent is present in the coating material. For example, a jelly coating material with a low amount of texture giving agent, but a high amount of water will result in a coating material which is more “jelly like”, and more fragile to rupture, while a jelly having a high content of texture giving agent will have a more hard or gummy like consistence like, a vine gum or a jelly bean.

Different flavours may be given to a jelly, for example different fruit flavours, liquorice extract, anise and menthol.

Thus, in an embodiment of the invention, the solidifying of the coating material is by cooling, gelling or drying or a combination thereof.

Applying the coating:

One aspect of the invention relates to a method of making a confectionery product, preferably frozen, with a patterned coating, comprising the steps of:

(i) providing a confectionery product having a surface;

(ii) providing a liquid coating material;

(iii) applying the liquid coating material to at least a part of the surface of the confectionery product;

(iv) allowing the coating material to flow down along the confectionery product; and

(v) solidifying the coating on the confectionery product to form a confectionery product with a patterned coating.

The patterned coating according to the present invention is made when applying a liquid coating material to the surface of the confectionery product and allowing the liquid coating material to flow down the surface of the confectionery product. Hereby, a pattern of the coating material will be made giving an interesting shape of the line between the coating material and the uncoated part of the product, i.e. the borderline. This borderline between the coated and uncoated part of the product will have a decorative effect. The decorative effect comes from the streams of coating material that hit the confectionery product.

In an embodiment of the invention, the liquid coating material is allowed to flow as a result of the liquid coating material having a viscosity and yield value suitable for the coating material to flow down the surface of the product by gravitation. Further, the liquid coating material will be applied in an amount sufficient to allow the coating material to flow. Preferably, the liquid coating material is applied from at least one applicator. An example of applying a coating material to a confectionery product according to present invention is to let the coating material permanently stream out of nozzles of an applicator and then lower the product down in close proximity to the nozzle, so that the stream of coating material hits the product. While the product passes through the stream of coating material, said material is applied to the surface. Excess material will flow down along the surface of the product and drip down from the tip of the product.

In case of application of lines exhibiting a wave form (created by rotating the nozzle forth and back), it is preferred to apply only a limited amount of coating material to the surface in order to prevent it from flowing down. In case of the material flowing down, this would create vertical lines.

In a preferred embodiment of the invention, the confectionery product is held upside-down when applying the coating material, such as in a vertical direction.

By the term “vertical” is meant that the shortest side of the product is in the top and bottom of the position of the product is held in.

An example of a product generally being in a vertical position when the coating material is applied is an ice stick, such as an ice lolly, or an ice cream cone.

In another embodiment of the invention, the confectionery product may be held upside-down, but in a in a horizontal position when the coating material is applied to the product. An example of a product which could be in a horizontal position when coating material is applied is an ice cream boat.

The term “horizontal” position is in the context of the present invention the opposite of a vertical position. In a horizontal position, the longest sides of the product are therefore in the top and the bottom of the product. In other word when a product is in a horizontal position, it is parallel to the level of the ground.

In an embodiment of the invention, the coating material is applied simultaneously at two or more positions.

The coating material may be applied to the surface of the confectionery product from an applicator.

In an embodiment of the invention the coating material is applied from at least one applicator.

The applicator applies a stream of liquid coating material to the confectionery product.

In another embodiment of the invention, the coating material is applied simultaneous from at least two applicators, such as at least three applicators, in particular at least 4 applicators, such as at least 5 applicators, for example from 5 at least 6 applicators.

In the context of the present invention, the term “applicator” means any device for applying the liquid coating material.

When a coating material is applied from 2 or more applicators, interesting patterns of the coating layer can be made, which improves visual appearance for the consumer.

The applicator may be provided with a nozzle for applying the coating material. The nozzle may be of different shapes dependent of which pattern is desired to make on the confectionery product.

In an embodiment of the invention, the applicator is provided with one or more nozzles for applying the liquid coating material.

In an embodiment of the application, the at least one applicator may be movable back and forward in a horizontal direction, such as movable to the left and the right. When a the applicator is movable in a horizontal direction, patterns having the shape of zig-zag lines may be performed when the coating material is flowing down the confectionery product.

In an embodiment of the invention, the at least one applicator and/or the confectionery product is movable in a vertical direction.

In an embodiment of the invention, a part of the confectionery product besides from being coated with a pattered coating layer will also before solidification be dipped in the liquid coating material. The product is dipped in a bath of the coating material being placed below the confectionery product. The dipping in the bath of coating material can either be before, after or simultaneous with applying the patterned coating.

In another embodiment of the invention, the confectionery product and at least one applicator is not movable in relation to each other, and the coating material is only applied by allowing the coating material to flow down along the product.

Pre-coating:

In an embodiment of the invention, the confectionery product may be precoated with a pre-coating layer.

The pre-coating layer is applied before the patterned coating layer according to the present invention and the pre-coating is applied either as a partially coating layer or a fully coating layer. The pre-coating layer may be any of the coating materials mentioned in this application used for giving the patterned coating, i.e. the liquid coating material. Preferably the pre-coating material is different from the liquid coating material used for the patterned coating layer.

In an embodiment of the invention, the pre-coating layer is a full coating.

In the context of the present invention, the term “full coating layer” means a layer covering the entire confectionery product.

In another embodiment of the invention, the pre-coating is a partly coating.

The term “partly coating” means in the context of the present invention a coating only covering a part of the confectionery product and thus leaving a part of the product uncoated.

The precoating layer may also be applied in a pattern according to the method according to present invention, but with a different type of coating, such that two or more patterns of coating layer are made of different types of coating, for example in different types of colours. The pre-coating layer applied may be one or more coating layers, such that the final confectionery product comprising a patterned coating layer and a precoating layer including at least two coating layers, such as three coating layers, for example four coating layers.

Thus, the method of applying a patterned coating according to the present invention may be repeated with either the same type of coating material or with different types of coating material to create different shapes of pattern on the confectionery product.

The pre-coating layer may be applied to a confectionery product by any method known in the art. The pre-coating layer can be applied by dipping, enrobing, or spraying the coating material onto the confectionery product. The coating material for the pre-coating layer may include one or more coating materials or a combination thereof, which are applied simultaneously or one-by-one.

In an embodiment of the invention, the surface of the confectionery product is uncoated when applying the coating material giving the patterned coating.

Patterns Formed:

In the context of the present invention, the term pattern generally relates to all patterns created when a coating material is flowing down along a product. The pattern may be any pattern formed from allowing a coating material to flow down along a product. It may be performed from one or two steams of coating material or it may be performed from several streams of coating material, such as from at least 3 streams, such as from 4 streams, in particular from 5 streams. The pattern may have different shapes such as stripes, waves or a as a zigzag pattern. The pattern are dependent of how many streams of coating material the coating are made of and how long the streams are allowed to flow down the product. Further, the pattern is dependent of whether the streams of coating material are placed with a uniform space between them or with a non-uniform spacing.

In an embodiment of the invention, the patterned coating is in a form of stripes or lines.

In an embodiment of the invention, the patterned coating is in a form of wide lines.

In another embodiment of the invention, the patterned coating is in the form of zig-zag lines.

In still another embodiment of the invention, the patterned coating is in the form of waves.

In the context of the present invention, stripes relates to a repeating symmetrical or geometrical pattern of continuous stripes placed at uniform or non-uniform intervals resulting in lines or stripes on the product.

Yet an aspect of the invention relates to a confectionery product comprising a patterned coating wherein said confectionery product is obtained by the method according to the invention.

In an embodiment of the invention, the confectionery product comprises a patterned coating wherein the borderline of the patterned coating is not a flat-line coating.

In still an embodiment of the invention, the confectionery product comprises a patterned coating wherein the patterned coating is a continuous coating. By the term “continuous coating” is meant that the coating is not ruptured and not made layer by layer, but in one piece.

A confectionery product comprising a patterned coating, preferably continuous, wherein said confectionery product is obtained by a method as here-in described is also an object of the invention. According to a particular embodiment, the confectionery is frozen and made of ice cream, low fat ice cream, mellorine, ice milk, water ice, sherbet, sorbet or frozen yoghurt and the confectionery product is on stick, placed in an edible container, placed in a sandwich between 2 edible components or placed in a non edible container.

It should be noted that embodiments and features described in the context of one of the aspects of the present invention also apply to the other aspects of the invention.

All patent and non-patent references cited in the present application, are hereby incorporated by reference in their entirety.

The invention will now be described in further details with reference to the figures.

### DESCRIPTION OF THE FIGURES

FIG. 1 shows application of a coating material from two applicators to the surface of a frozen confection on a stick to make stripes/lines with the coating material.

FIG. 1 illustrates a frozen confection (1) on a stick (2) held upside down. Coating material (4) is applied to the surface of the frozen confection from two applicators (3) placed near the surface of the frozen confection. The coating material (4) is allowed to flow down along the surface of frozen confection and excess coating material will drip from the frozen confection. As indiated by the arrow, the frozen confection on a stick is able to move up and down in relation to the applicators. An applicator consist of a nozzle through which the coating material streams out permanently. The coating is supplied to the nozzle via a pipe connected to a tank storing the coating material. A decorative pattern in the form of lines or stripes are made of the coating material.

In an alternative solution more applicators may be provided for example 3, 4 or 5 nozzles, such that stripes of coating material are provided several places around the confectionery product. This makes an even better visual appearance of the product.

FIG. 2 shows application of a coating material from two applicators which can be moved back and forward in a horizontal position so make zig-zag lines of a coating material on an frozen confection on a stick.

FIG. 2 illustrates a frozen confection (1) on a stick (2) held upside down. Coating material (4) is applied to the surface of the frozen confection from two applicators (3) placed near the surface of the frozen confection. As indiated by the arrow, the applicators and the surface of the frozen confection is able to move back and forward in a horizontal and vertical position in relation to each other. Hereby, a decorative pattern in form of zig-zag lines are created with the coating material FIG. 3 shows application of a coating material from two applicators as in FIG. 2, but with nozzles providing wider lines.

FIG. 3 illustrates a frozen confection (1) on a stick (2) held upside down. Coating material (4) is applied to the surface of the frozen confection from two applicators (3) placed near the surface of the frozen confection. The nozzles of the applicator are broader than the ones used in FIG. 2. The coating material is allowed to flow down along the surface of frozen confection, and a decorative pattern of the coating material having wide zig zag lines of coating material are created.

FIG. 4 shows application of a coating material to a frozen confection on a stick as in FIG. 1, but with nozzles providing wider lines.

FIG. 4 illustrates a frozen confection (1) on a stick (2) held upside down. Coating material (4) is applied to the surface of the frozen confection from two applicators (3) placed near the surface of the frozen confection. The coating material (4) is allowed to flow down along the surface of the frozen confection and excess coating material will drip from the frozen confection. A decorative pattern in the form of lines or stripes wider than in FIG. 1 are created from the coating material.

FIG. 5 shows application of a coating material to an frozen confection on a stick as in FIG. 4, but where the top of frozen confection is further dipped in a bath of coating material once two streams of coating material are applied.

FIG. 5 illustrates an frozen confection (1) on a stick (2) placed upside down, which frozen confection has lines of coating material applied as in FIG. 4. The frozen confection is placed over a bath (6) of coating material, such that the frozen confection will be dipped in a bath of coating material to cover the top of the frozen confection with coating material.

FIG. 6 shows a frozen confection on a stick (2) with stripes of coating material (5) and the top (7) of the frozen confection covered with coating material.

FIG. 7 illustrates two frozen confections (1) on sticks (2) with a coating layer (8) shaped as two different types of waves.

FIG. 8 shows application of a coating material to a flame cone filled with a frozen confection to make a visual decorative effect.

FIG. 8 illustrates the coating material (14) is applied from two applicators (13) to the surface of the frozen confection (11) in a cone (12) when it is held upside down. A decorative pattern in the form of lines or stripes (15) are created from the coating material

FIG. 9 shows application of a coating material to a sandwich filled with a frozen confection to make a visual decorative effect FIG. 9 illustrates the coating material (24) is applied from two applicators (23) to the surface of the frozen confection (21) in a sandwich (22) when it is held upside down.

A decorative pattern in the form of lines or stripes are created from the coating material.

FIG. 10 shows application of a lines of coating material to a frozen confection on a stick, where the frozen confection is moulded as a 6-star.

FIG. 10 illustrates stream of the coating material (34) from applicators (33) flowing down along a 6-star moulded frozen confection (31) 6 places, in the cavity of the shaped stars. When flowing down the frozen confection, the coating material creates stripes of coating material.

FIG. 11 illustrates a 6-star moulded frozen confection (31) on a stick (32) prepared from the applicator shown in FIG. 10 with coating material in lines (35).

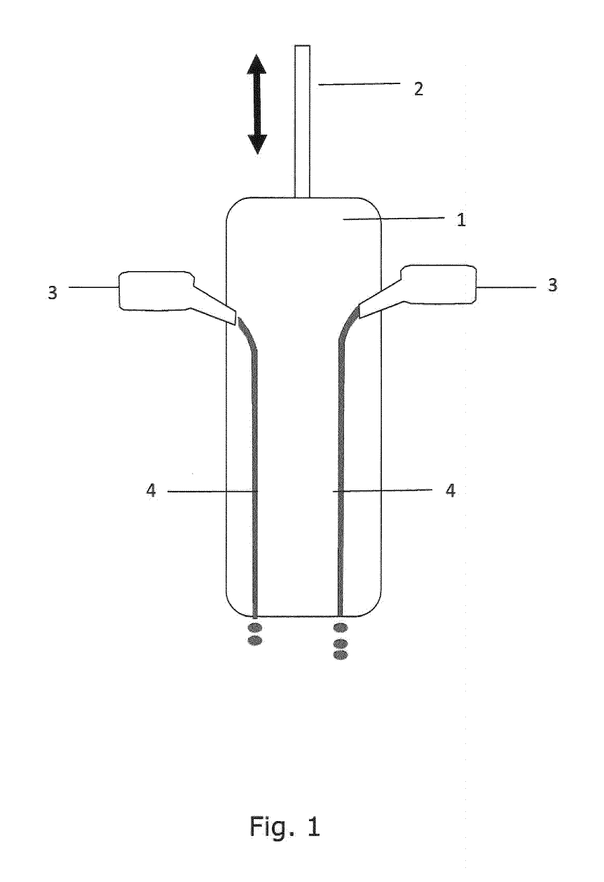

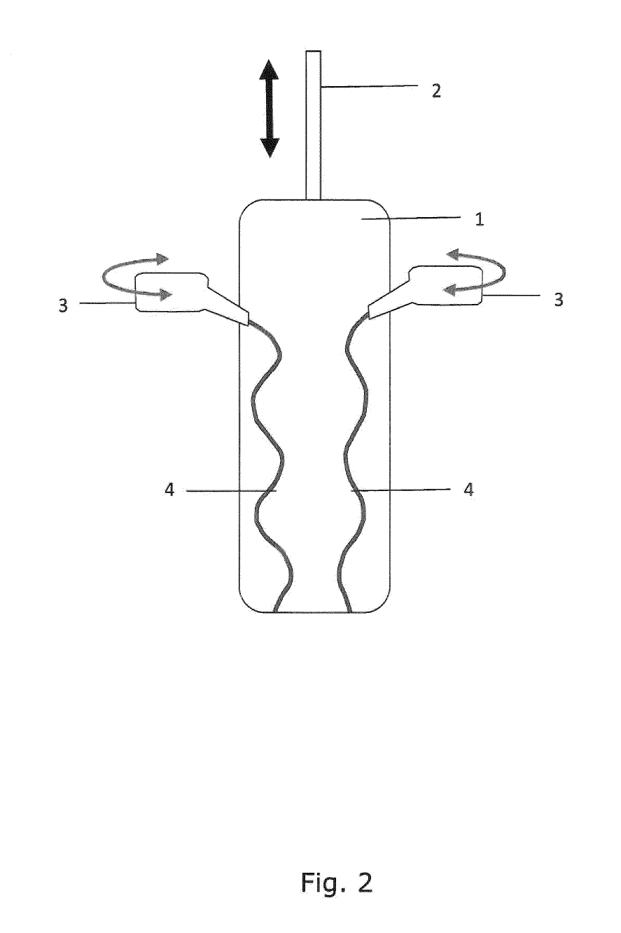

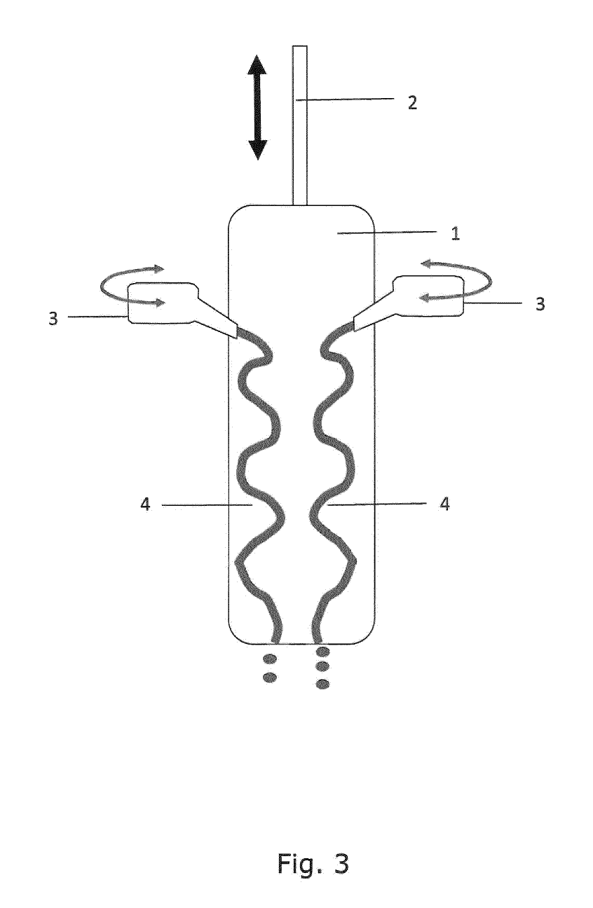

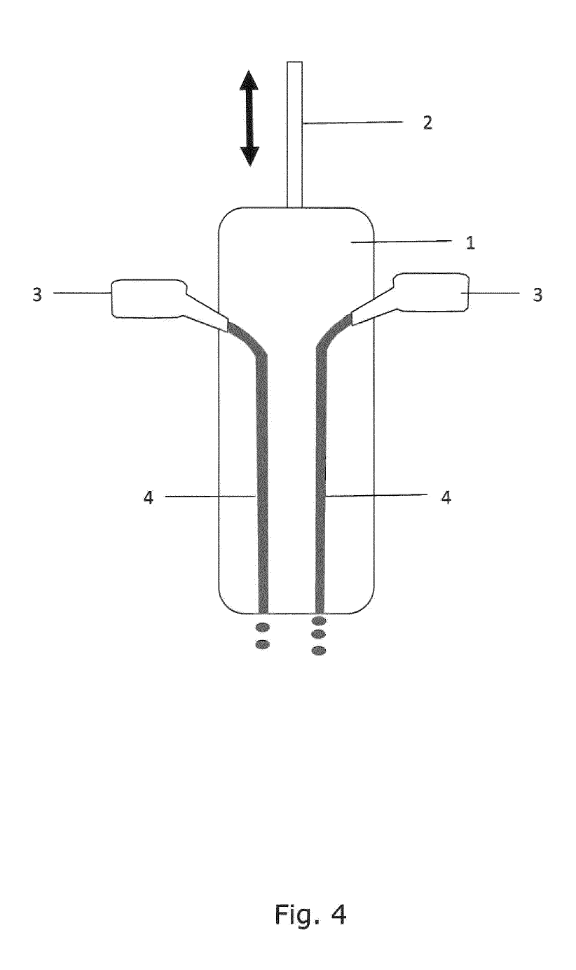

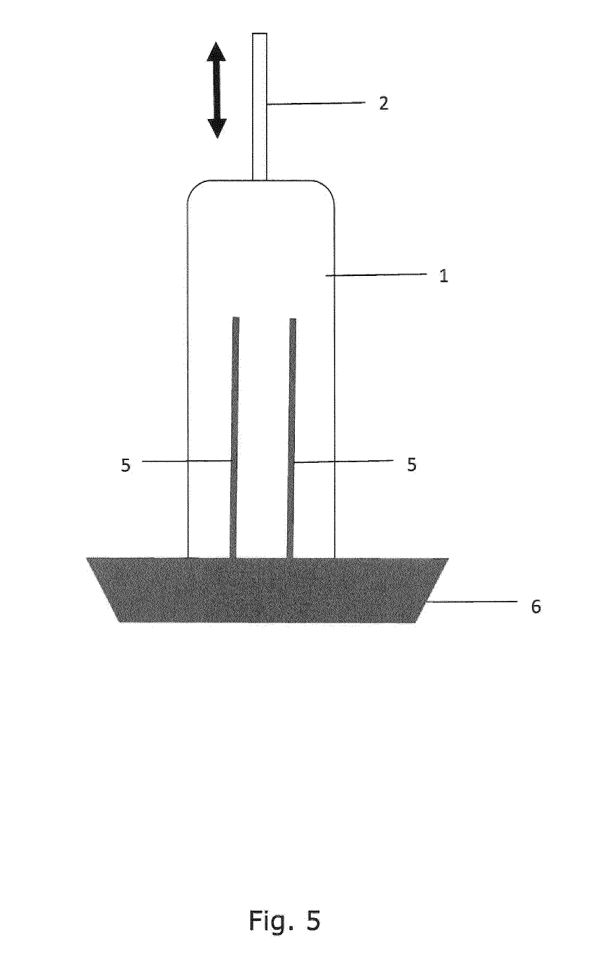

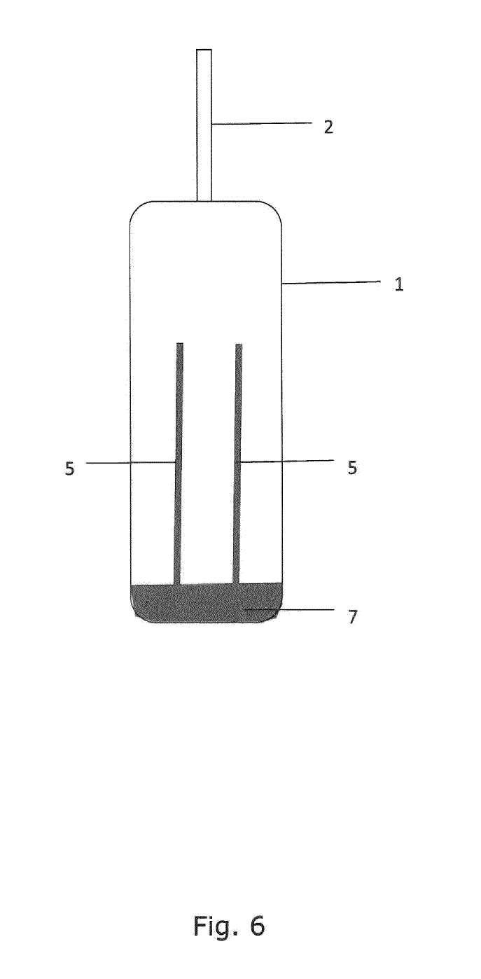

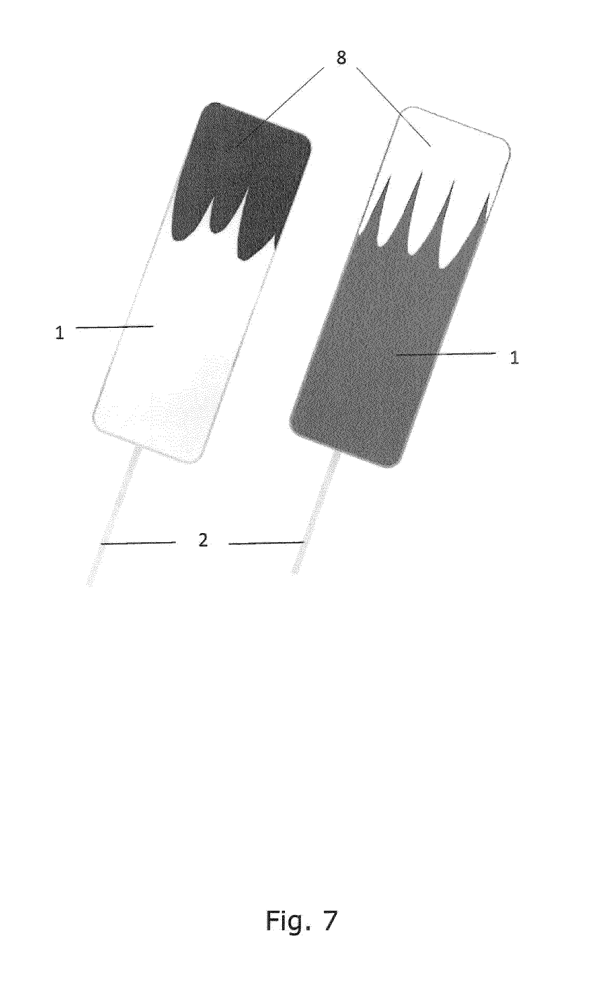

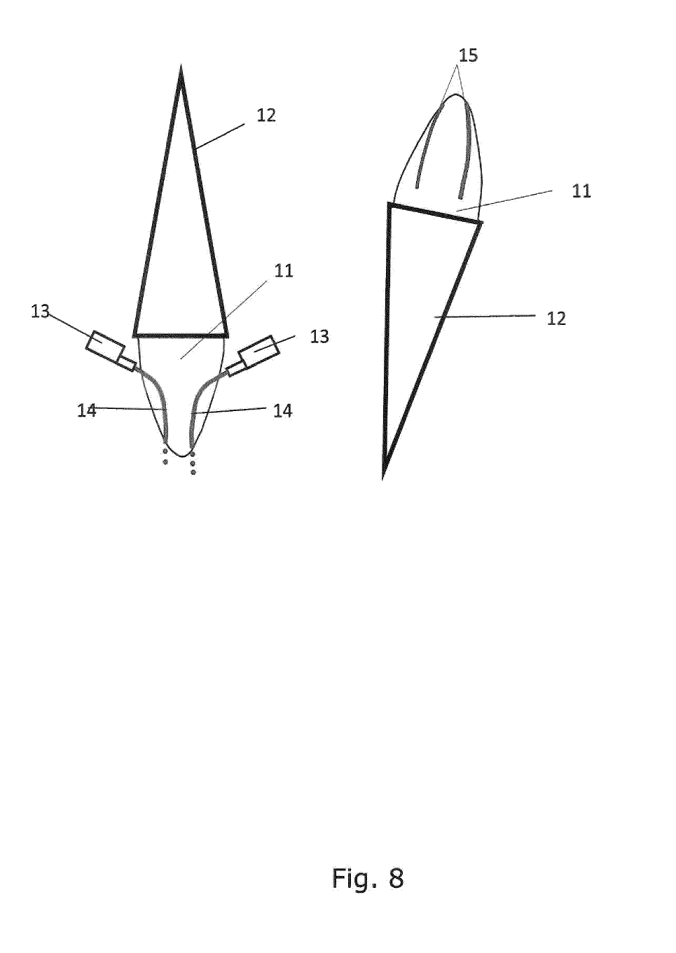

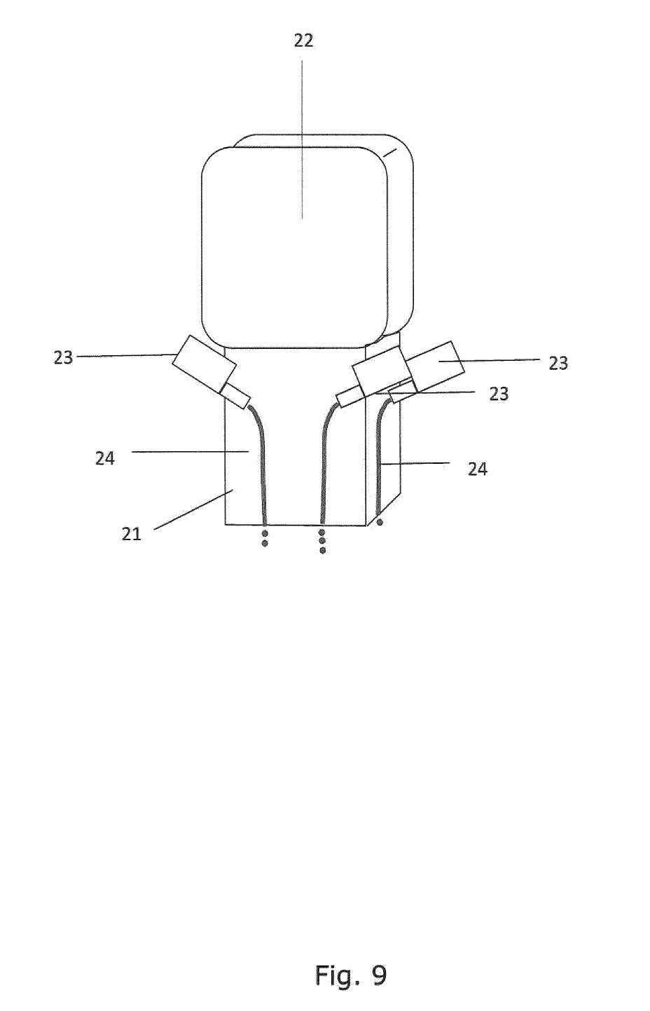

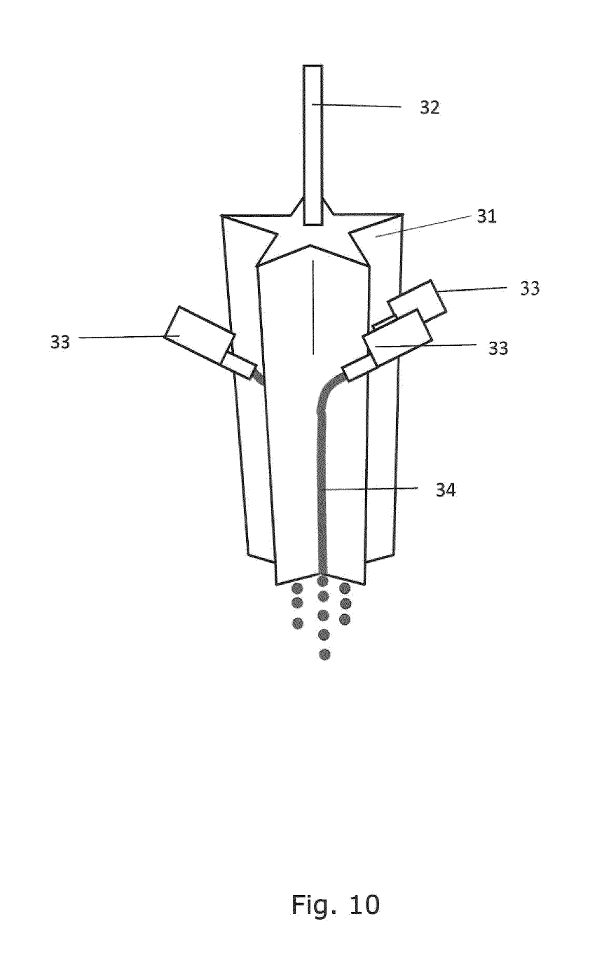

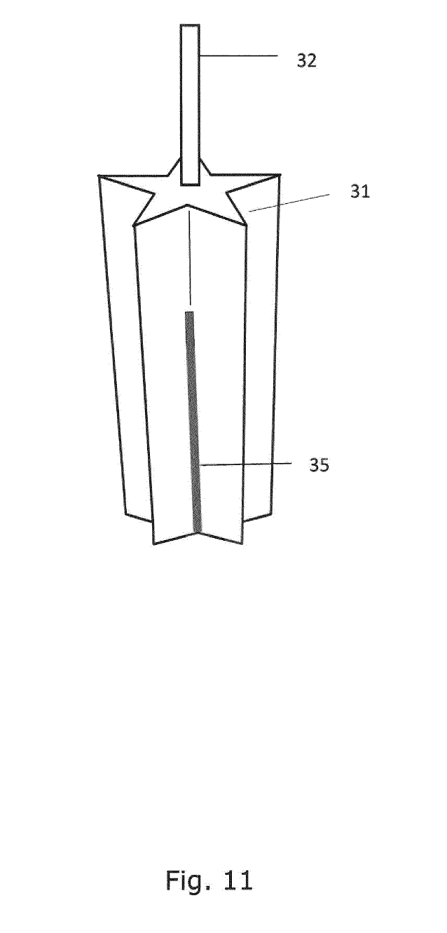

1. A method of making a confectionery product, with a patterned coating, comprising the steps of:
providing a confectionery product having a surface;
providing a liquid coating material;
applying the liquid coating material to at least a part of the surface of the confectionery product;
allowing the coating material to flow down along the confectionery product; and
solidifying the coating on the confectionery product to form a confectionery product with a patterned coating.

2. The method according to claim 1, wherein before solidification, a part of the confectionery product is dipped in a liquid coating material.

3. The method according to claim 1, wherein the confectionery product is held upside down when the liquid coating material is applied to the surface of the confectionery product.

4. The method according to claim 1, wherein the confectionery product is made of a composition selected from the group consisting of ice cream, low fat ice cream, mellorine, ice milk, sherbet, sorbet and frozen yoghurt and wherein the confectionery product is positioned at a location selected from the group consisting of
on a stick,
in an edible container,
in a sandwich between two edible materials; and,
in a non-edible container.

5. The method according to claim 1, wherein the confectionery product is molded.

6. The method according to claim 1, wherein the confectionery product is on a stick.

7. The method according to claim 1, wherein the coating material is selected from the group of chocolate, jelly, fruit sauce preparations, compound coatings and combinations thereof.

8. The method according to claim 7, wherein the coating material is chocolate.

9. The method according to claim 1 wherein the coating material is applied simultaneously at two or more positions on the surface of the confectionery product.

10. The method according to claim 1, wherein the patterned coating is in a form selected from the group consisting of stripes, lines, zig-zag lines and waves.

11. The method according to claim 1, wherein the liquid coating material is applied from at least one applicator.

12. The method according to claim 11, wherein the at least one applicator is movable in a vertical direction.

13. A confectionery product comprising a patterned coating wherein said-the confectionery product is obtained by a method comprising the steps of providing a confectionery product having a surface, providing a liquid coating material, applying the liquid coating material to at least a part of the surface of the confectionery product, allowing the coating material to flow down along the confectionery product, and solidifying the coating on the confectionery product to form a confectionery product with a patterned coating.

14. The confectionery product according to claim 13, wherein the patterned coating is a continuous coating.

15. The confectionery product according to claim 13, wherein the confectionery product is made of a composition selected from the group consisting of ice cream, low fat ice cream, mellorine, ice milk, water ice, sherbet, sorbet and frozen yoghurt and wherein the confectionery product is positioned at a location selected from the group consisting of
on a stick,
placed in an edible container,
placed in a sandwich between two edible materials, and
placed in a non-edible container.
